(19) United States
(12) Patent Application Publication
(10) Pub. No.: US 2011/0276207 A1
(43) Pub. Date: Nov. 10, 2011

(54) METHOD FOR OPERATING A DRIVE OF A MOTOR VEHICLE, AS WELL AS A DRIVE DEVICE AND AN ELECTRONIC CONTROL UNIT

(76) Inventor: Jens-Werner Falkenstein, Aalen (DE)

(21) Appl. No.: 13/063,036

(22) PCT Filed: Aug. 13, 2009
(86) PCT No.: PCT/EP2009/060498

§ 371 Date: May 26, 2011

(30) Foreign Application Priority Data
Sep. 9, 2008 (DE) 10 2008 041 897.8

(51) Int. Cl. B60W 20/00

(52) U.S. Cl. 701/22; 180/65.275; 903/902

(57) ABSTRACT

A method is described for operating a drive of a motor vehicle that has at least two shafts, each able to be driven by a shaft drive device, a total drive torque of the motor vehicle corresponding generally to the sum of the shaft torques applied to the shafts. In this context, it is provided that a quantity and/or a change in the quantity of one of the shaft torques is/are taken into account in the open-loop and/or closed-loop control of the remaining shaft torques. A drive device of a motor vehicle as well as an electronic control unit are also described.

### FIELD OF THE INVENTION

The present invention relates to a method for operating a drive of a motor vehicle that has at least two shafts, each able to be driven by a shaft drive device, a total drive torque of the motor vehicle corresponding generally to the sum of the shaft torques applied to the shafts. The present invention further relates to a drive device and an electronic control unit.

### BACKGROUND INFORMATION

Methods of the type mentioned above may be used in electric-powered vehicles or hybrid vehicles, in which shafts connected to wheels of the motor vehicle are coupled via a substructure connected to the wheels. In this type of motor vehicles, it is possible to dispense with a transfer case, e.g., a central differential or axle differential. Usually, in each case, the individual shafts are assigned a shaft drive device, by which they are able to be driven. The total drive torque of the motor vehicle is impressed on the shafts by the shaft drive devices, so that the total drive torque corresponds generally to the sum of the individual shaft torques. Consequently, an open-loop and/or closed-loop control must be implemented, which distributes the desired total drive torque of the motor vehicle to the individual shaft torques. For example, a method for the open-loop and closed-loop control of the operating dynamics in motor vehicles having a hybrid drive is described in German Patent Application No. DE 10 2004 049 324 A1. This method is intended to be used for drives having at least one electric motor and an internal combustion engine. In this case, a total drive torque is divided between the electric motor and the internal combustion engine in such a way that the setpoint drive torque desired by the driver is generated in sum.

At the same time, the intention is to influence a yawing moment and therefore the self-steering properties of the motor vehicle. In this connection, steering interventions are also provided. A distribution rate is calculated, which corresponds to the ratio of the torque of the at least one electric motor to the total drive torque. Thus, the torques of the electric motor and of the internal combustion engine are determined and transmitted to them. In certain operating conditions of the drive, e.g., in the event the internal combustion engine and/or the electric motor fails, the operational safety of the motor vehicle may thus be impaired since, for instance, a portion of a drive torque or braking torque drops out and the total drive torque changes.

### SUMMARY

A method for operating a drive of a motor vehicle in accordance with an example embodiment of the present invention may have the advantage that the indicated impairment of the operational safety of the motor vehicle is prevented by avoiding dangerous changes of the total drive torque. This is achieved by taking a quantity and/or a change in the quantity of one of the shaft torques into account in an open-loop and/or closed-loop control of the remaining shaft torques. The actual quantity of one of the shaft torques thus influences the determination of the remaining shaft torques. They may also be controlled and/or regulated accordingly, as soon as a change in the quantity of one of the shaft torques is determined. The drive of the motor vehicle has at least two drivable shafts. For example, the front axle and rear axle may thus be driven separately by one shaft drive device each in this context, the front axle and rear axle may in each instance have an axle differential, or perhaps each wheel of the motor vehicle may be connected to a separate shaft drive device. The total drive torque of the motor vehicle corresponds generally to the sum of the individual shaft torques. In this manner, dangerous operating conditions which could follow at least a partial failure of one of the shaft drive devices may be substantially avoided. The failure of the shaft drive device causes a change in the quantity of one of the shaft torques, so that the quantity thereby existing may be taken into consideration in the open-loop and/or closed-loop control of the remaining shaft torques. For example, it may be provided to adjust the remaining shaft torques so that the change in the quantity of the one shaft torque is offset, It is also possible for the motor vehicle to be stabilized by the open-loop and/or closed-loop control in the event the change in the quantity of the one shaft torque has given rise to an instability. The method of the present invention may be used advantageously for drives where the individual shafts each have a shaft drive device and are not connected to each other. However, it may also be employed if at least two of the shafts are connected to each other via a coupling, e.g., via a controllable mechanical clutch that may be used as a multidisk clutch along the lines of a central differential. The method is usable particularly advantageously for electric-powered vehicles or hybrid vehicles having several powered axles. In the latter case, a unit made up of an internal combustion engine, transmission and possibly an electric motor usually acts on one of the shafts, while one or more further shaft(s) is/are driven by electric motors in conjunction with a transmission. In this context, shaft is to be understood in the sense of a powered axle. For instance, the electric motor connected to the internal combustion engine may be a belt starter generator, which is operated to start the internal combustion engine and as a generator. However, the method is also suitable for drives which provide a plurality of similar shaft drive devices.

In a further development of the present invention, an internal combustion engine or an electric motor or a hybrid drive device having at least two different power plants, especially an electrical and an internal combustion engine, or a hydraulic machine is used as at least one of the shaft drive devices. The shaft may thus be driven by shaft drive devices of the most varied type. At least one, of the shaft drive devices may be in the form of the internal combustion engine, the electric motor, the hybrid drive device or the hydraulic machine. In this context, the hybrid drive device has at least two power plants which preferably are different and are formed, for example, by the electric motor and the internal combustion engine.

A further refinement of the present invention provides that the total drive torque corresponds generally to a setpoint drive torque predefined by a driver of the motor vehicle and/or by a driver assistance system. Thus, during normal operation of the drive, the total drive torque should be matched to a driver input. For instance, the driver may input the setpoint drive torque via an accelerator pedal. An influence of the driver assistance system on the total drive torque or the setpoint drive torque is also possible. The driver assistance system may be formed by various electronic auxiliary devices, e.g., a system for maintaining a constant speed, a brake assistant, a system for maintaining a certain distance from other motor vehicles or a stability system. Both the driver of the motor vehicle and the driver assistance system have influence on the setpoint drive torque which, just like the quantity and/or the change in the quantity of one of the shaft torques, is taken into account in the open-loop and/or closed-loop control of the remaining shaft torques. During normal operation of the motor vehicle, the open-loop and/or closed-loop control sets the shaft torques in such a way that the total drive torque, which corresponds to the sum of the shaft torques applied to the shafts, is equal to or at least nearly equal to the setpoint drive torque.

In a further development of the present invention, in the event the total drive torque deviates from the setpoint drive torque because of a limitation of at least one shaft torque, the deviation of the total drive torque is accomplished steadily and/or in a manner that limits the rate of change. If there is a limitation of at least one of the shaft torques, then the case may occur that the setpoint drive torque cannot be reached due to the limitation, and the total drive torque deviates from it. In this case, the deviation or the change in the total drive torque is intended to take place steadily and/or in a manner that limits the rate of change. For example, the limitation may exist because of limits of the shaft drive device (performance limits of the internal combustion engine or the charge level and/or load and/or capacity limits of an energy store or of a traction battery), because of a speed regulation (e.g., boost speed regulation, in order to distribute an available energy content of the energy store or of the traction battery over several boost procedures), because of an emergency-operation condition of one shaft drive device (e.g., due to a dysfunction in a transmission), because of a gear shift in the transmission or because of an operating dynamics system. The latter may influence individual shafts, for example, in order to avoid locking of the shaft or of the wheel disposed on it. The limitation may also come about due to spinning or slipping of the wheels of the motor vehicle on the ground below. In this case, power cannot be transferred sufficiently to the ground below to achieve the setpoint drive torque. Due to the limitation, at least a portion of one of the shaft torques drops out, so that the total drive torque may rise or fall suddenly. In order to ensure the safety of the motor vehicle, the total drive torque should therefore be adjusted or changed steadily and/or in a manner that limits the rate of change. This means that no or at least only slight sudden changes take place during the deviation of the total drive torque after the occurrence of the limitation. It may also be provided to determine a rate of the deviation of the total drive torque from the setpoint drive torque by way of a rate-of-change limitation. This means, for example, that in response to a rapid change of the setpoint drive torque, the total drive torque should change rapidly.

A further refinement of the present invention provides that after the limitation has ceased, the total drive torque is brought in line with the setpoint drive torque in a manner that is steady and/or that limits the rate of change. Thus, when the limitation is no longer applicable, the shaft torques may be adjusted again by the open-loop and/or closed-loop control in such a way that their sum corresponds to the setpoint drive torque. To prevent an abrupt change in the total drive torque, which could influence the safety of the motor vehicle, the total drive torque is altered steadily and/or in a manner that limits the rate of change. This means that the deviation of the total drive torque from the setpoint drive torque is reduced steadily and/or with limitation in the rate of change. The change is implemented until the total drive torque corresponds generally to the setpoint drive torque again. In this manner, the driver of the motor vehicle has sufficient time to adapt himself to the altered operating conditions, and perhaps to adjust the setpoint drive torque. Naturally, in this case, the setpoint drive torque may likewise be adjusted by the driver assistance system.

A further development of the present invention provides that, in order to change the total drive torque steadily and/or in a manner that limits the rate of change, at least one of the shaft drive devices is operated in an overload range and/or at an unfavorable operating point. During normal operation of the motor vehicle, thus, when there is no limitation, the shaft drive devices are to be operated in such a way that there is neither an overload, nor is the shaft drive device operated at an unfavorable operating point. For instance, the latter may be characterized by high specific fuel consumption and/or high emissions values. On the other hand, if the limitation is present and, because of the limitation of at least one of the shaft torques, the setpoint drive torque cannot be reached, particularly without overloading or unfavorable operating points, then at least one of the shaft drive devices may be operated in the overload range and/or at the unfavorable operating point, in order to allow the total drive torque to change in a manner which is steady and/or limited in the rate of change. For example, in response to the failure of one of the shaft drive devices, a further shaft drive device is operated with a higher output, in doing which, only a short-duration operation is possible without damage to the shaft drive device, and at the same time, the specific fuel consumption is high. During the operation of the shaft drive device in such a manner, the total drive torque is changed steadily and/or in a manner that limits the rate of change, so that the total drive torque is adjusted to a value which permits operation of the shaft drive device in a permanently permissible range. In this manner, the safety of the motor vehicle may be increased considerably by the short-duration operation of the shaft drive device outside of the permanently permissible and/or desired range. Since the shaft drive device is operated in the undesirable range for only a short period, it can suffer no damage.

In a further refinement of the present invention, in order to change the total drive torque steadily and/or in a manner that limits the rate of change, the total drive torque is filtered and/or altered in accordance with a ramp. The total drive torque is intended to change slowly and non-abruptly. This may be achieved by using a filter and/or by altering the total drive torque according to the characteristic of the ramp, which may be predefined.

In another refinement of the present invention, the total drive torque is changed in such a way that an absolute value of the total drive torque is less than an absolute value of the setpoint drive torque, and/or the total drive torque approaches zero. Thus, during the change of the total drive torque, its absolute value is not to exceed that of the setpoint drive torque. The altered total drive torque should thus always lie between the original value of the total drive torque or of the setpoint drive torque and a value of zero. In this manner, the total drive torque can not increase or decrease unexpectedly for the driver. It may, therefore, also be provided for the total drive torque to approach zero. For instance, this may be provided in response to an especially serious fault in one of the shaft drive devices, in order to bring the motor vehicle safely to a halt. This means that if the vehicle is in traction mode with positive total drive torque, the total drive torque should be reduced in the direction of zero as soon as a limitation exists, in order to avoid an unintentional acceleration of the vehicle. Conversely, in the case of a negative total drive torque, thus, the motor vehicle is in overrun, the total drive torque should preferably be altered in the direction of zero as soon as the limitation occurs, in order to prevent a sudden deceleration.

In a further development of the present invention, the setpoint drive torque is filtered. Thus, the setpoint drive torque does not correspond directly to the input by the driver of the motor vehicle, but rather is only coupled to it. It is provided to filter the input of the driver and/or of the driver assistance system before the total drive torque of the motor vehicle is adapted to it. This is intended to prevent the total drive torque of the motor vehicle from being able to change too rapidly and/or abruptly.

In one further refinement of the present invention, a minimum torque and/or a maximum torque is/are established for at least one of the shafts. The shaft drive device connected to the shaft is thus preassigned a torque range in which it is operated. The shaft torque is controlled and/or regulated in such a way that it is greater than the minimum torque or less than the maximum torque or lies between the minimum torque and the maximum torque. The minimum torque and/or the maximum torque may be determined based on the minimally and/or maximally achievable torque of the shaft drive device and/or may describe a favorable operating range. The minimum torque and/or maximum torque may thus be selected in such a way that the shaft drive device is operated at a favorable operating point, e.g., with low specific fuel consumption and/or low emission of pollutants. If a limitation exists, it is then possible to deviate from these ideal torques. This means that the minimum torque and/or the maximum torque may be set to different values.

Another refinement of the present invention provides for setting the minimum torque and/or maximum torque as a function of a torque range able to be made available by the shaft drive device and/or a speed regulation of one of the shaft drive devices and/or an emergency operation/fault condition and/or a gear shift in a transmission and/or values of a vehicle dynamics control. The minimum torque and/or maximum torque may thus be adapted to the torque range able to be made available by the shaft drive device, or to an optimal torque range of the same. The minimum torque and/or the maximum torque may also be set based on a speed regulation of one of the shaft drive devices. For instance, the speed regulation may be provided due to a malfunction or an unfavorable operating condition (e.g., overheating). The speed regulation may also be provided in the form of a boost speed regulation in order to distribute the available energy content of the electrical energy store or of the traction battery over several boost procedures. In addition, recognized emergency operation/fault conditions and gear shifts are incorporated into the values of the minimum torque and/or maximum torque. It is also advantageous if the permissible torque range, thus, the range bounded by the minimum torque and/or maximum torque, is set as a function of values of a vehicle dynamics control. This may be provided in order to increase the stability of the motor vehicle.

In a further development of the present invention, the torque range of the shaft drive device is specified as a function of the power plants of the hybrid drive device. If the hybrid drive device is provided as shaft drive device, then the torque range is adapted to the power plants of the hybrid drive device. This means that not merely one of the power plants, but rather the totality is considered. For example, the torque range is set to a torque range which is defined by an internal combustion engine and an electric motor.

A further refinement of the present invention provides that the shaft drive device is allowed to operate in an overload range and/or at an unfavorable operating point by adapting the minimum torque and/or maximum torque. During normal operation, the minimum torque and/or maximum torque is/are determined so that operation is not allowed in the overload range and/or at the unfavorable operating point. For example, if, due to the limitation, it should become necessary to operate at least one of the shaft drive devices in the overload range and/or at the unfavorable operating point, the minimum torque and/or the maximum torque is/are then adjusted accordingly, so that the shaft drive device is allowed to operate in the corresponding range.

In another development of the present invention, an inertia of moving elements, especially of the shafts and/or of wheels assigned to the shafts and or of the power plants, is taken into account in the open-loop and/or closed-loop control of the remaining shaft torques. During an acceleration, e.g., a rotational acceleration, especially of the shafts, a portion of the shaft torque generated is needed to accelerate the inert mass of the rotating shaft. The equivalent holds true for a deceleration of the shaft, as well. This means that the total drive torque is decreased by this portion. A high rotational acceleration may occur when a vehicle dynamics system or a gear shift of the transmission influences the minimum or maximum torque of one of the shafts. The portion by which the total drive torque is reduced is now not to be taken into account in the open-loop and/or closed-loop control of the remaining shaft torques, since it effectively is not available to the drive of the motor vehicle. In particular, the focus is on the portion which is present at the elements to be assigned to the one shaft torque.

In one further refinement of the present invention, the inertia is taken into account by using a low-pass filter and/or by ascertaining the acceleration and the inertia of the moving elements. In order to offset the inertia described above, a low-pass filter may be used in an implementation easy to realize. It may be applied to the quantities used for the open-loop and/or closed-loop control, such as the quantity and/or the change in the quantity and/or intermediate values calculated during the open-loop and/or closed-loop control, in order to reduce the dynamics of an open-loop and/or closed-loop control system. Alternatively, the accelerations, particularly rotational accelerations, and the moments of inertia, for example, of the shafts and/or of wheels assigned to the shafts and/or of the power plants, may be ascertained. Based on these values, an exact correction by the amount of the portion of torque which is not available due to the acceleration and/or deceleration may be made.

The present invention further relates to a drive device of a motor vehicle, particularly for implementing the example method described above, having at least two shafts, each able to be driven by a shaft drive device, a total drive torque of the motor vehicle corresponding generally to the sum of the shaft torques applied to the shafts. In this context, based on a quantity and/or change in the quantity of one of the shaft torques, the remaining shaft torques are controlled in open loop and/or closed loop. The drive device has at least two different or similar power plants. For instance, the drive device may be a hybrid drive device having at least two different power plants. In this context, it is advantageous if at least one electric motor and at least one internal combustion engine are assigned to the hybrid drive device.

The present invention further includes an electronic control unit, particularly for implementing the example method and/or for controlling an example drive device described above, for the open-loop and/or closed-loop control of shaft torques of the at least two shafts able to be driven in each case by a shaft drive device, a total drive torque of the motor vehicle corresponding generally to the sum of the shaft torques applied to the shafts. A quantity and/or change in the quantity of one of the shaft torques is taken into account in the open-loop and/or closed-loop control of the remaining shaft torques. The control unit is therefore used to implement the method described and/or for the closed-loop/open-loop control of the drive device. The drive device may be in the form of a hybrid drive device and, for example, as already mentioned, may have at least one internal combustion engine and at least one electric motor.

### BRIEF DESCRIPTION OF THE DRAWINGS

The present invention is explained in greater detail below based on the exemplary embodiments shown in the figures, without restricting the present invention.

FIG. 1 shows a schematic representation of a motor vehicle having a drive and having two shafts able to be driven by shaft drive devices.

FIG. 2 shows a schematic which describes the coordination of shaft torques applied to the shafts.

### DETAILED DESCRIPTION OF EXAMPLE EMBODIMENTS

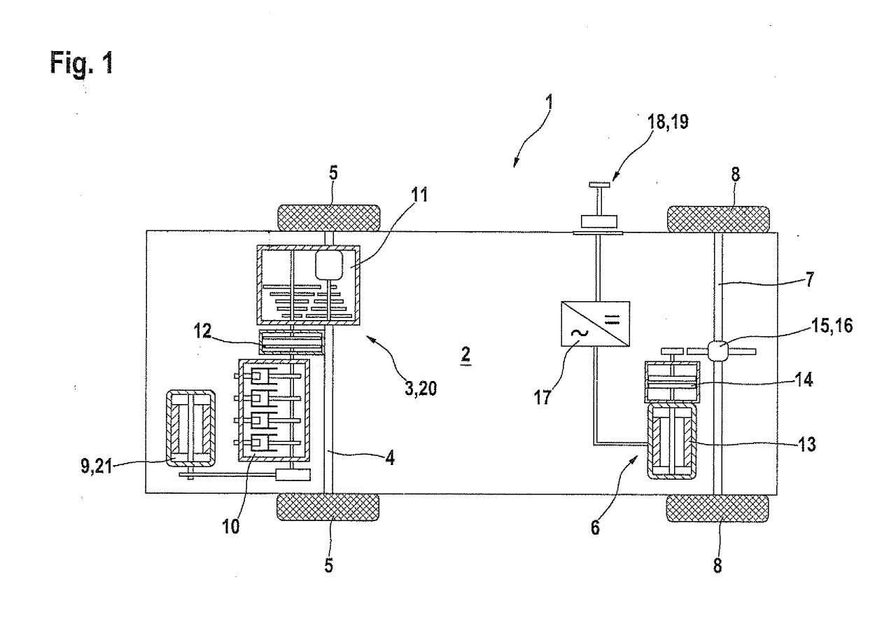

FIG. 1 shows a schematic representation of a motor vehicle 1 having a drive 2 which, with the aid of a first shaft drive device 3, drives a first shaft 4, and via it, wheels 5, as well as a second shaft drive device 6 which drives wheels 8 via a shaft 7. First shaft drive device 3 has an electric motor 9, an internal combustion engine 10 and a transmission 11. Electric motor 9 and internal combustion engine 10 are coupled to each other via suitable means. The unit made up of electric motor 9 and internal combustion engine 10 is connected via a clutch 12 to a transmission 11 which implements a speed or torque conversion and is operably connected on its output side to shaft 4. Shaft 4 is thus able to be driven via the combination of electric motor 9 and internal combustion engine 10. Second shaft drive device 6 has an electric motor 13 which is connected via a coupling 14 to a transmission 16 in the form of simple speed-transforming transmission 15, to shaft 7. Shaft 7 is thus able to be driven via electric motor 13. Electric motor 13 is also connected via power electronics 17 to a traction battery 19 serving as energy store 18. It can be maintained that first shaft drive device 3, which has electric motor 9 and internal combustion engine 10, represents a hybrid drive device 20. Wheels 5 and 8 are connected to a substructure (not shown), on which motor vehicle 1 is able to move. Wheels 5 and 8, i.e., first shaft drive device 3 and second shaft drive device 6 are therefore in operative connection with each other via this substructure. This means that the shaft torques generated by first and second shaft drive devices 3 and 6 add up to form the total drive torque of motor vehicle 1. In this context, the shaft torques may in each case be positive or negative. For example, it may be provided to power motor vehicle 1 by internal combustion engine 10, while electric motor 13 is being operated in a generator mode, and therefore is charging traction battery 19. Electric motor 9 is designed as belt starter generator 21. It is able to start internal combustion engine 10, and during operation of internal combustion engine 10, it is able to generate current for an electrical system (not shown) of motor vehicle 1. The sum of the torques applied to both wheels 5 corresponds to the shaft torque generated by first shaft drive device 3; the sum of the torques applied to both wheels 8 corresponds to the shaft torque generated by second shaft drive device 6. Transmissions 11 and 16 include axle differentials (not shown). In most driving situations, one half the shaft torque is distributed to each of the two wheels, even in the case of different wheel speeds. A distribution differing from that may arise if the axle differential has a locking effect. As an alternative, instead of electric motor 13, two individual electric motors may be used, each of which drives one of wheels 8. A setpoint drive torque, predefined by a driver of motor vehicle 1 or by a driver assistance system (not shown), and possibly filtered for reasons of comfort, is distributed over the shaft torques of both shafts 4 and 7.

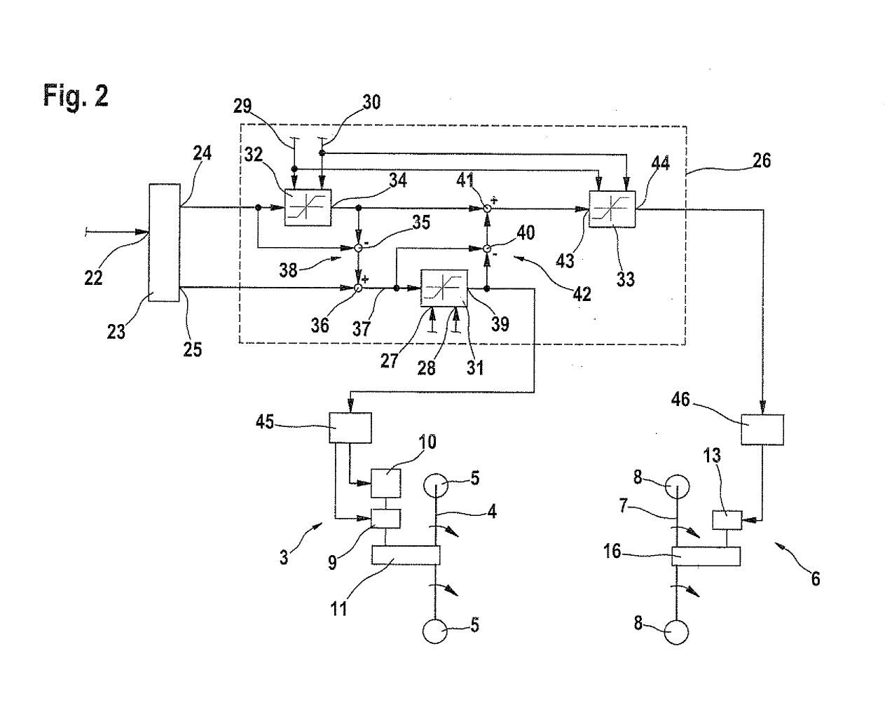

FIG. 2 shows a schematic which illustrates the coordination of the shaft torques applied to shafts 4 and 7. A setpoint drive torque mₛₑₜₚₒᵢₙₜ is specified at an input 22 of a calculating unit 23. For example, this setpoint drive torque is a function of an input by the driver of motor vehicle 1 or a function of the driver assistance system. Calculating unit 23 splits the setpoint drive torque into shaft setpoint torques M_{A1,setpoint} und M_{A2,setpoint}. The first is made available at a first output 25, the second at a second output 24 of calculating unit 23. Both values M_{A1,setpoint} und M_{A2,setpoint} are used as input quantities of a limiter unit 26. The limiter unit is provided with a quantity M_{A1,min} (minimum torque of shaft 4, i.e., of shaft drive device 3) at an input 27, a torque M_{A1,max} (maximum torque of shaft 4, i.e., of shaft drive device 3) at an input 28, a torque M_{A2,min} (minimum torque of shaft 7, i.e., of shaft drive device 6) at an input 29, and a torque M_{A2, max} (maximum torque of shaft 7, i.e., of shaft drive device 6) at an input 30. Limiter unit 26 has a first limiter 31, a second limiter 32 and a third limiter 33. Inputs 27 and 28 are associated with first limiter 31; inputs 29 and 30 are associated with second and third limiters 32 and 33, respectively. Second output 24 of calculating unit 23 is linked to second limiter 32. Signal M_{A2,setpoint} applied there is therefore limited by signals M_{A2,min} and M_{A2,max} applied to inputs 29 and 30. Therefore, a limited torque between (including) M_{A2,min} and M_{A2,max} is present at an output 34 of the second limiter. A difference between this limited torque and torque M_{A2,setpoint} is calculated at a node 35. At a further node 36, this calculated difference is added to torque M_{A1,setpoint} present at first output 25 of calculating unit 23. The result of this addition is applied to input 37 of first limiter 31. Nodes 35 and 36 form a first interconnection 38. It is used in the manner described to add the difference between the input and output torque of second limiter 32 to the torque present at first output 25 of calculating unit 23. First limiter 31 limits the value formed by the addition and applied to input 37, with values M_{A1,min} and M_{A1,max} applied to inputs 27 and 28. The result of this limitation is output at output 39. Analogous to node 35, at a node 40, a difference is calculated between the input signal and output signal of first limiter 31, thus, the values present at input 37 and output 39. At a node 41, this difference is added to the torque present at output 34. Nodes 40 and 41 represent a further interconnection 42. The signal formed by the addition at node 41 is used at input 43 as input signal of third limiter 33. Also applied to it are signals M_{A2,min} and M_{A2,max} applied to inputs 29 and 30. Limiter 33 limits the signal present at input 43 with the two last-named values. The limited value is present at output 44. The signal present at output 39 is denoted as M_{A1,setpoint,lim} and the signal present at output 44 is denoted as M_{A2,setpoint,lim}. They represent output signals of limiter unit 26. Shaft setpoint torques M_{A1,setpoint} und M_{A2,setpoint} are thus limited in limiters 31, 32 and 33 by respective minimum torques _{MA1,min} and M_{A2},ₘᵢₙ ,ₘᵢₙ as well as maximum torques M_{A1,max} and M_{A2,max}. Interconnections 38 and 42 ensure that the portion of torque (difference between the unlimited and the limited shaft setpoint torque) not representable at one shaft is transferred to the respective other shaft. Output 39 of first limiter 31 is connected to a calculating unit 45. Minimum-/maximum torques M_{A1,min}, M_{A2,min}, M_{A2,max}, are determined on the basis of torque ranges able to be made available by shaft drive devices 3 and 6, speed regulations, emergency operation-/fault conditions of shaft drive devices 3 and 6, gear shifts in transmissions 11 and 16 as well as vehicle dynamics systems. In so doing, transmission ratios of transmissions 11 and 16 must be taken into consideration. In the case of several power plants of one shaft drive device 3, 6, the individual power plant limits must be combined, thus, for example, a torque range both of electric motor 9 and of internal combustion engine 10 must be taken into account. For instance, if electric motor 13 of second shaft drive device 6 fails suddenly as a result of a fault condition, then minimum torque M_{A2,min} and maximum torque M_{A2,max} of second shaft drive device 6 jump to zero or to the friction torque or loss torque occurring upon rotation of shaft drive device 6.

Interconnection 38 then allocates a portion of torque not representable at second shaft drive device 6, to first shaft drive device 3. Calculating unit 45 divides limited shaft setpoint torque M_{A1,setpoint,lim} into torques M_{ICE,1} and M_{el,l}. The first represents a torque of internal combustion engine 10, the second a torque of electric motor 9. In this context, calculating unit 45 takes an existing transmission ratio of transmission 11 into account. Interconnected electric motor 9 and internal combustion engine 10 output the torque generated by them to transmission 11. It provides for a speed-/torque conversion and outputs the converted torque to shaft 4, i.e., wheels 5. The torque resulting from the conversion by transmission 11 is denoted as shaft torque M_{A1}. In most driving situations, this torque M_{A1} is distributed uniformly to wheels 5, so that at both wheels 5, in each case ½M_{A1} is transmitted to the ground below. On the other hand, the signal at output 44 is used as input signal of a calculating unit 46. From the value M_{A2,setpoint,lim}, it calculates a torque M_{e1,2} which is to be generated by electric motor 13. In so doing, the transmission ratio of transmission 16 is taken into consideration by calculating unit 46. Electric motor 13 thus generates torque M_{e1,2}, which is converted by transmission 16 to shaft torque M_{A2}. This torque M_{A2} is applied to shaft 7, i.e., to wheels 8. As described above, in most driving situations of motor vehicle 1, torque M_{A2} is distributed uniformly to wheels 8, so that torque ½M_{A2} is present at each of the two wheels.

In quasi steady-state operation, that is, given low rotational accelerations at the rotating parts of the assemblies of shaft drive device 3 (electric motor 9, internal combustion engine 10, transmission 11, clutch 12), shaft torque M_{A1} corresponds approximately to limited shaft setpoint torque M_{A1,setpoint,lim}. At high rotational accelerations, portions of the torques generated are needed to accelerate or decelerate the inert masses of the rotating parts. Shaft torque M_{A}), deviates from limited shaft setpoint torque M by these inertia M_{A1,setpoint,lim} portions. The equivalent holds true for shaft drive device 6; at high rotational accelerations, shaft torque M_{A2} deviates from limited shaft setpoint torque M_{A2,setpoint,lim}. High rotational accelerations may be present in particular when vehicle dynamics systems or gear shifts in transmissions 11, 16 influence limited shaft setpoint torque M_{A1,setpoint,lim} or limited shaft setpoint torque M_{A2,setpoint,lim}. For example, when a vehicle dynamics system raises limited shaft setpoint torque M_{A1,setpoint,lim} by increasing limit M_{A1,min} in order to avoid locking of wheels 5 and to accelerate the rotating parts of the assemblies of shaft drive device 3. Effective shaft torque M_{A1} then differs from limited shaft setpoint torque M_{A1,setpoint,lim} by the inertia portions. In a further refinement of the exemplary embodiment, corresponding inertia portions are corrected in interconnections 38 and 42, so that only the effective torque differentials are transferred to the respective other shaft. In the simple case, to that end, the output signals of nodes 35 and 40 may be low-pass-filtered in order to reduce the dynamics. An exact correction may be achieved by ascertaining the rotational accelerations and the moments of inertia of the rotating parts. A similar correction may also be made to compensate for inertias of the wheels or for control dynamics of the power plants.

The performance of limiter unit 26 may be adjusted via the quantities applied to inputs 27, 28, 29 and 30. Normally, torques M_{A1,min}, M_{A1,max}, M_{A2,min} and M_{A2,max} are set in such a way that shaft drive devices 3 and 6 are in a normal operating range, that is, not in an overload range and/or at an unfavorable operating point. If the normal operating range changes at one shaft drive device 3 or 6 or a limitation of one of the shaft torques applied to shafts 4 and 7 arises, the minimum and maximum torques may then be adjusted in such a way that shaft drive devices 3 and 6 are allowed to be operated at least for a short period in an overload range and/or at an unfavorable operating point. In this manner, it is possible to prevent a sudden change in a total drive torque of motor vehicle 1, which is made up of shaft torques M_{A1} and M_{A2} of shafts 4 and 7. The safety of motor vehicle 1, particularly in the case of an existing limitation, is thereby increased. For example, the limitation of one of shaft drive devices 3 and 6 may exist because of torque ranges, speed regulations, emergency-operation conditions, gear shifts and/or inputs of vehicle dynamics systems. In this case, it may happen that the total drive torque of motor vehicle 1, thus, M_{A}=M_{A1}+M_{A2}, will deviate from predefined setpoint drive torque M_{A,setpoint}, which is applied to input 22. In this case, care should be taken that the total drive torque of the motor vehicle is changed steadily and/or in a manner that limits the rate of change, so that no sudden changes can occur in the total drive torque.

1-17. (canceled)

18. A method for operating a drive of a motor vehicle which has at least two shafts, each able to be driven by a shaft drive device, a total drive torque of the motor vehicle corresponding to a sum of shaft torques applied to the shafts, the method comprising:
determining at least one of a quantity and a change in the quantity of one of the shaft torques; and
controlling remaining ones of the shaft torques taking into account the determination.

19. The method as recited in claim 18, wherein at least one of the shaft drives is one of an internal combustion engine, an electric motor, a hybrid drive device having at least two different power plants, or a hydraulic machine.

20. The method as recited in claim 18, wherein the total drive torque corresponds to a setpoint drive torque predefined by at least one of a driver of the motor vehicle, and a driver-assistance system.

21. The method as recited in claim 20 further comprising:
changing the total drive torque at least one of steadily and in a manner that limits a rate of change, if the total drive torque deviates from the setpoint drive torque due to a limitation of at least one shaft torque.

22. The method as recited in claim 21, further comprising:
changing the total drive torque in line with the setpoint drive torque at least one of steadily and in a manner that limits the rate of change.

23. The method as recited in claim 22, wherein to change the total drive torque at least one of steadily and in a manner that limits the rate of change, at least one of the shaft drive devices is operated at least one of in an overload range, and at an unfavorable operating point.

24. The method as recited in claim 22, wherein to change the total drive torque at least one of steadily and in a manner that limits the rate of change, the total drive torque is at least one of filtered and altered according to a ramp.

25. The method as recited in claim 22, wherein the total drive torque is changed in such a way that at least one of: i) an absolute value of the total drive torque is less than an absolute value of the setpoint drive torque, and ii) the total drive torque approaches zero.

26. The method as recited in claim 22, wherein the setpoint drive torque is filtered.

27. The method as recited in claim 18, further comprising:
determining, for at least one of the shafts, at least one of a minimum torque and a maximum torque.

28. The method as recited in claim 18, further comprising:
setting at least one of a minimum torque and maximum torque, as a function of a torque range able to be made available by at least one of: i) the shaft drive device, ii) a speed regulation of one of the shaft drive devices, an emergency operation-/fault condition, iii) a gear shift in a transmission, and iv) values of a vehicle dynamics control.

29. The method as recited in claim 18, wherein the shaft drive devices include a hybrid drive device, and the method further comprises:
determining a torque range of the shaft drive device as a function of power plants of the hybrid drive device.

30. The method as recited in claim 28, wherein the shaft drive device is operated in an in at least one of overload range and at an unfavorable operating point, by adapting the at least one of the minimum torque and the maximum torque.

31. The method as recited in claim 18, wherein an inertia of moving elements is taken into account in the control of the remaining shaft torques.

32. The method as recited in claim 31, wherein the moving elements include at least one of the shafts and wheels assigned to the shafts.

33. The method as recited in claim 31, wherein the inertia is taken into account at least one: i) by using a low-pass filter, and ii) by ascertaining acceleration and the inertia of the moving elements.

34. A drive device of a motor vehicle having at least two shafts, each of the shafts able to be driven by a shaft drive device, a total drive torque of the motor vehicle corresponding to a sum of shaft torques applied to the shafts, the drive device configured to determine at least one of a quantity and a change in the quantity, of one of the shaft torques, and to control remaining ones of the shaft torques taking into account the determination.

35. An electronic control unit for a motor vehicle, the control unit controlling shaft torques of at least two shafts, each of the shafts able to be driven by a shaft drive device, a total drive torque of the motor vehicle corresponding to a sum of shaft torques applied to the shafts, the electronic control unit configured to determination at least one of a quantity and a change in the quantity, of one of the shaft torques, and configured to control the remaining shaft torques taking into account the determination.
